(19) United States
(12) Patent Application Publication
(10) Pub. No.: US 2026/0351552 A1
(43) Pub. Date: Nov. 5, 2026

(54) NEGATIVE ELECTRODE FOR RECHARGEABLE LITHIUM BATTERY, RECHARGEABLE LITHIUM BATTERY COMPRISING THE SAME, AND METHOD OF PREPARING NEGATIVE ELECTRODE

(71) Applicant: SAMSUNG SDI CO., LTD., Yongin-si (KR)

(72) Inventor: Kihwan KWON, Yongin-si (KR)

(73) Assignee: SAMSUNG SDI CO., LTD., Yongin-si (KR)

(21) Appl. No.: 19/638,670

(22) Filed: Apr. 3, 2026

(30) Foreign Application Priority Data
Apr. 30, 2025 (KR) 10-2025-0056936

(51) Int. Cl. H01M 4/04; H01M 4/02; H01M 4/133; H01M 4/134; H01M 4/1393; H01M 4/1395; H01M 4/38; H01M 4/485; H01M 4/587; H01M 4/62; H01M 10/0525

(52) U.S. Cl. CPC H01M 4/0445; H01M 4/0419; H01M 4/0435; H01M 4/133; H01M 4/134; H01M 4/1393; H01M 4/1395; H01M 4/386; H01M 4/485; H01M 4/587; H01M 4/622; H01M 2004/021; H01M 2004/027; H01M 2004/028; H01M 10/0525

(57) ABSTRACT

The present disclosure relates to a negative electrode for a rechargeable lithium battery, a rechargeable lithium battery comprising the same, and a manufacturing method thereof. More specifically, the negative electrode comprises a negative electrode current collector, a prelithiated carbon layer on the negative electrode current collector; and a negative electrode active material layer on the prelithiated carbon layer. An atomic fraction of lithium atoms in the prelithiated carbon layer is greater than an atomic fraction of lithium atoms in the negative electrode active material layer.

### CROSS-REFERENCE TO RELATED APPLICATION

This U.S. nonprovisional application claims priority under 35 U.S.C § 119 to Korean Patent Application No. 10-2025-0056936 filed on Apr. 30, 2025, in the Korean Intellectual Property Office, the disclosure of which is hereby incorporated by reference in its entirety.

### BACKGROUND

One or more example embodiments of the present disclosure relate to a negative electrode for a rechargeable lithium battery and a rechargeable lithium battery comprising the same. More particularly, the present disclosure relates to a dry negative electrode for a rechargeable lithium battery for pre-lithiation, a rechargeable lithium battery comprising the same, and a manufacturing method thereof.

A rechargeable lithium battery is a battery comprising a positive electrode and a negative electrode including an active material capable of intercalation and deintercalation of lithium ions, and an electrolyte. The battery produces electrical energy by oxidation and reduction reactions occurring when lithium ions are intercalated and deintercalated at the positive electrode and the negative electrode.

### SUMMARY

One or more example embodiments of the present disclosure are directed toward a negative electrode for a rechargeable lithium battery having improved initial irreversible capacity through pre-lithiation by disposing a lithium metal layer on a negative electrode carbon layer during a dry negative electrode plate manufacturing process, and a rechargeable lithium battery comprising the same.

According to one or more example embodiments of the present disclosure, a dry negative electrode for a rechargeable lithium battery comprises: a negative electrode current collector; a prelithiated carbon layer on the negative electrode current collector; and a negative electrode active material layer on the prelithiated carbon layer, wherein an atomic fraction of lithium atoms in the prelithiated carbon layer is greater than an atomic fraction of lithium atoms in the negative electrode active material layer.

According to one or more example embodiments of the present disclosure, a rechargeable lithium battery comprises: a positive electrode; a negative electrode; and an electrolyte between the positive electrode and the negative electrode, wherein the negative electrode comprises the dry negative electrode for a rechargeable lithium battery according to the present disclosure.

According to one or more example embodiments of the present disclosure, a method of manufacturing a dry negative electrode for a rechargeable lithium battery comprises: forming a carbon layer on a negative electrode current collector; disposing a lithium metal layer on the carbon layer; spraying an electrolyte on the lithium metal layer to form a prelithiated carbon layer; and providing a negative electrode active material layer manufactured by a dry process on the prelithiated carbon layer.

### BRIEF DESCRIPTION OF DRAWINGS

FIG. 1 is a conceptual diagram briefly illustrating a rechargeable lithium battery according to example embodiments of the present disclosure.

FIG. 2 to FIG. 5 are cross-sectional views schematically illustrating rechargeable lithium batteries according to various example embodiments.

FIG. 6 is a cross-sectional view illustrating a rechargeable lithium battery according to example embodiments of the present disclosure.

FIG. 7 is an enlarged view illustrating a difference in atomic fraction of lithium between a prelithiated carbon layer and a negative electrode active material layer of FIG. 6.

FIG. 8a and FIG. 8b are conceptual diagrams illustrating lithium intercalated between carbon layers.

FIG. 9 is a cross-sectional view of a negative electrode in which a lithium metal layer is inserted between a prelithiated carbon layer and a negative electrode active material layer.

FIG. 10 and FIG. 11 are cross-sectional views for explaining a process of manufacturing a negative electrode according to example embodiments of the present disclosure.

### DETAILED DESCRIPTION

In order to fully understand the configuration and effects of the present disclosure, example embodiments of the present disclosure are described with reference to the accompanying drawings. However, the present disclosure is not limited to the example embodiments disclosed below, but may be implemented in various forms and various changes may be made. The example embodiments are provided to make the disclosure of the present disclosure complete and to fully inform those skilled in the art of the scope of the disclosure.

In this specification, when a component is referred to as being “on” another component, it may be directly formed on the other component, or a third component may be interposed therebetween. Furthermore, in the drawings, the thickness of components may be exaggerated for effective description of technical content. Throughout the specification, the same reference numerals represent the same components.

Unless otherwise expressly stated, the singular forms “a,” “an,” and “the” may include plural referents. Furthermore, unless otherwise expressly stated, “A or B” may mean “including A, including B, or including both A and B.” The terms “comprises” and/or “comprising” as used herein do not exclude the presence or addition of one or more other components.

As used herein, the term “combination thereof” may refer to a mixture, a laminate, a composite, a copolymer, an alloy, a blend, or a reaction product of the constituent elements.

When the terms “about” or “substantially” are used in this specification in connection with a numerical value, it is intended that the associated numerical value includes a tolerance of +10% around the stated numerical value. When ranges are specified, the range includes all values therebetween such as increments of 0.1%.

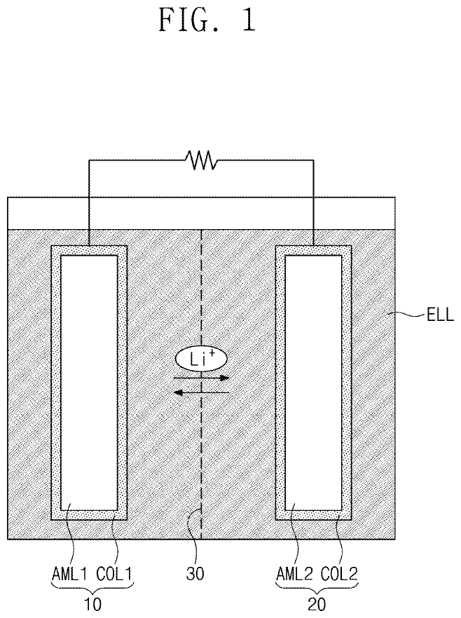

FIG. 1 is a conceptual diagram briefly illustrating a rechargeable lithium battery according to example embodiments of the present disclosure. Referring to FIG. 1, the rechargeable lithium battery may include a positive electrode 10, a negative electrode 20, a separator 30, and an electrolyte ELL.

The positive electrode 10 and the negative electrode 20 may be spaced apart from each other with the separator 30 interposed therebetween. The separator 30 may be disposed between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may include a medium for transferring lithium ions between the positive electrode 10 and the negative electrode 20. Within the electrolyte ELL, the lithium ions may pass through the separator 30 and move toward the positive electrode 10 or the negative electrode 20.

### Positive Electrode 10

A positive electrode 10 for a rechargeable lithium battery may include a current collector COL1 and a positive electrode active material layer AML1 formed on the current collector COL1. The positive electrode active material layer AML1 includes a positive electrode active material and may further include a binder and/or a conductive material. As an example, the positive electrode 10 may further include an additive configured to serve as a sacrificial positive electrode.

The content of the positive electrode active material in the positive electrode active material layer AML1 may include about 90 wt % to about 99.5 wt % based on 100 wt % of the positive electrode active material layer AML1. The content of the binder and the conductive material may each be about 0.5 wt % to about 5 wt % based on 100 wt % of the positive electrode active material layer AML1.

The binder serves to bond positive electrode active material particles to each other and to bond the positive electrode active material to the current collector COL1. Representative examples of the binder include, but are not limited to, polyvinyl alcohol, carboxymethyl cellulose, hydroxypropyl cellulose, diacetyl cellulose, polyvinyl chloride, carboxylated polyvinyl chloride, polyvinyl fluoride, polymers containing ethylene oxide, polyvinyl pyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, and nylon.

The conductive material is used to provide conductivity to the electrode. Any electron-conductive material can be used as long as it does not cause a chemical change in the battery. Examples of the conductive material include carbon-based materials such as natural graphite, synthetic graphite, carbon black, acetylene black, ketjen black, carbon fiber, carbon nanofiber, and carbon nanotube; metal-based materials including metal powders or metal fibers of copper, nickel, aluminum, and silver; conductive polymers such as polyphenylene derivatives; or mixtures thereof.

As the current collector COL1, Al may include used but is not limited thereto.

The positive electrode 10 may include manufactured by a wet process of coating a positive electrode active material layer AML1 on the current collector COL1, but may also be manufactured by a dry process of forming a positive electrode film independently of the current collector COL1 and then rolling the same.

### Positive Electrode Active Material

As the positive electrode active material in the positive electrode active material layer AML1, a compound capable of reversible intercalation and deintercalation of lithium (a lithiated intercalation compound) may include used. Specifically, one or more composite oxides of lithium and a metal selected from cobalt, manganese, nickel, and combinations thereof may include used.

The composite oxide may include a lithium transition metal composite oxide, and specific examples may include lithium nickel-based oxide, lithium cobalt-based oxide, lithium manganese-based oxide, lithium iron phosphate-based compound, cobalt-free nickel-manganese-based oxide, or combinations thereof.

As an example, a compound represented by any one of the following chemical formulas may include used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GeO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-g}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the chemical formulas, A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

As an example, the positive electrode active material may include a high-nickel positive electrode active material in which the content of nickel is about 80 mol % or more, about 85 mol % or more, about 90 mol % or more, about 91 mol % or more, or about 94 mol % or more and about 99 mol % or less based on 100 mol % of metals excluding lithium in the lithium transition metal composite oxide. High-nickel positive electrode active materials can realize high capacity and thus may include applied to high-capacity, high-density rechargeable lithium batteries.

### Negative Electrode 20

A negative electrode 20 for a rechargeable lithium battery comprises a current collector COL2 and a negative electrode active material layer AML2 disposed on the current collector COL2. The negative electrode active material layer AML2 includes a negative electrode active material and may further include a binder and/or a conductive material.

For example, the negative electrode active material layer AML2 may include about 90 wt % to about 99 wt % of the negative electrode active material, about 0.5 wt % to about 5 wt % of the binder, and about 0 wt % to about 5 wt % of the conductive material.

The binder serves to bond the negative electrode active material particles to each other and to bond the negative electrode active material to the current collector COL2. As the binder, a non-aqueous binder, an aqueous binder, a dry binder, or a combination thereof may include used.

Examples of the non-aqueous binder include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamideimide, polyimide, or combinations thereof.

The aqueous binder may include selected from styrene-butadiene rubber, (meth)acrylated styrene-butadiene rubber, (meth)acrylonitrile-butadiene rubber, (meth)acrylic rubber, butyl rubber, fluoro rubber, polyethylene oxide, polyvinylpyrrolidone, polyepichlorohydrin, polyphosphazene, poly(meth)acrylonitrile, ethylenepropylene diene copolymer, polyvinylpyridine, chlorosulfonated polyethylene, latex, polyester resin, (meth)acrylic resin, phenol resin, epoxy resin, polyvinyl alcohol, and combinations thereof.

When an aqueous binder is used as the negative electrode binder, a cellulose-based compound configured to provide viscosity may include further included. The cellulose-based compound may include one or more of carboxymethyl cellulose, hydroxypropylmethyl cellulose, methyl cellulose, or alkali metal salts thereof. The alkali metal may include Na, K, or Li.

The dry binder may include a fibrillatable polymer material, such as polytetrafluoroethylene, polyvinylidene fluoride, polyvinylidene fluoride-hexafluoropropylene copolymer, polyethylene oxide, or combinations thereof.

The conductive material is used to provide conductivity to the electrode. Any electron-conductive material can be used as long as it does not cause a chemical change in the battery. Specific examples include carbon-based materials such as natural graphite, synthetic graphite, carbon black, acetylene black, ketjen black, carbon fiber, carbon nanofiber, and carbon nanotube; metal-based materials including metal powders or metal fibers of copper, nickel, aluminum, and silver; conductive polymers such as polyphenylene derivatives; or mixtures thereof.

The current collector COL2 may include selected from copper foil, nickel foil, stainless steel foil, titanium foil, nickel foam, copper foam, a polymer substrate coated with a conductive metal, and combinations thereof.

### Negative Electrode Active Material

The negative electrode active material in the negative electrode active material layer AML2 includes a material capable of reversibly intercalating/deintercalating lithium ions, lithium metal, an alloy of lithium metal, a material capable of being doped and de-doped with lithium, or a transition metal oxide.

The material capable of reversibly intercalating/deintercalating lithium ions may include a carbon-based negative electrode active material, such as crystalline carbon, amorphous carbon, or a combination thereof. Examples of the crystalline carbon include graphite such as natural graphite or synthetic graphite in an amorphous, plate, flake, spherical, or fibrous form. Examples of the amorphous carbon include soft carbon, hard carbon, mesophase pitch carbide, and calcined coke.

The alloy of lithium metal may include an alloy of lithium and a metal selected from Na, K, Rb, Cs, Fr, Be, Mg, Ca, Sr, Si, Sb, Pb, In, Zn, Ba, Ra, Ge, Al, and Sn.

As the material capable of doping and de-doping lithium, a Si-based negative electrode active material or a Sn-based negative electrode active material may include used. The Si-based negative electrode active material may include silicon, a silicon-carbon composite, SiOₓ (0<x<2), a Si-Q alloy (wherein Q is selected from an alkali metal, an alkaline earth metal, a Group 13 element, a Group 14 element (excluding Si), a Group 15 element, a Group 16 element, a transition metal, a rare earth element, and a combination thereof), or a combination thereof. The Sn-based negative electrode active material may include Sn, SnO₂, a Sn-based alloy, or a combination thereof.

The silicon-carbon composite may include a composite of silicon and amorphous carbon. According to one embodiment, the silicon-carbon composite may include in a form in which amorphous carbon is coated on a surface of silicon particles. For example, it may include secondary particles (core) in which primary silicon particles are assembled and an amorphous carbon coating layer (shell) disposed on the surface of the secondary particles. The amorphous carbon may also be disposed between the primary silicon particles; for example, the primary silicon particles may include coated with amorphous carbon. The secondary particles may include dispersed in an amorphous carbon matrix.

The silicon-carbon composite may further include crystalline carbon. For example, the silicon-carbon composite may include a core comprising crystalline carbon and silicon particles, and an amorphous carbon coating layer disposed on the surface of the core.

The Si-based negative electrode active material or Sn-based negative electrode active material may include used in a mixture with the carbon-based negative electrode active material.

### Separator 30

Depending on the type of rechargeable lithium battery, a separator 30 may include present between the positive electrode 10 and the negative electrode 20. The separator 30 may include a single-layer or multi-layer film comprising polyethylene, polypropylene, or polyvinylidene fluoride. For example, a multi-layer film such as a polyethylene/polypropylene two-layer separator, a polyethylene/polypropylene/polyethylene three-layer separator, or a polypropylene/polyethylene/polypropylene three-layer separator may include used.

The separator 30 may include a porous substrate and a coating layer disposed on one or both surfaces of the porous substrate, the coating layer comprising an organic material, an inorganic material, or a combination thereof.

The porous substrate may include a polymer film formed of a polyolefin such as polyethylene or polypropylene; a polyester such as polyethylene terephthalate or polybutylene terephthalate; polyacetal; polyamide; polyimide; polycarbonate; polyetherketone; polyaryletherketone; polyetherimide; polyamideimide; polybenzimidazole; polyethersulfone; polyphenylene oxide; cyclic olefin copolymer; polyphenylene sulfide; polyethylene naphthalate; glass fiber; teflon; polytetrafluoroethylene; or a copolymer or mixture of two or more thereof.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and inorganic material may include present as a mixture in a single coating layer, or a coating layer containing the organic material and a coating layer containing the inorganic material may include laminated.

### Electrolyte ELL

The electrolyte ELL for a rechargeable lithium battery includes a non-aqueous organic solvent and a lithium salt.

The non-aqueous organic solvent serves as a medium through which ions involved in the electrochemical reaction of the battery can move.

The non-aqueous organic solvent may include a carbonate-based, ester-based, ether-based, ketone-based, or alcohol-based solvent, an aprotic solvent, or a combination thereof.

Examples of the carbonate-based solvent include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), and butylene carbonate (BC).

Examples of the ester-based solvent include methyl acetate, ethyl acetate, n-propyl acetate, dimethyl acetate, methyl propionate, ethyl propionate, decanolide, mevalonolactone, valerolactone, and caprolactone.

Examples of the ether-based solvent include dibutyl ether, tetraglyme, diglyme, dimethoxyethane, 2-methyltetrahydrofuran, 2,5-dimethyltetrahydrofuran, and tetrahydrofuran. Cyclohexanone may include used as a ketone-based solvent. Examples of the alcohol-based solvent include ethyl alcohol and isopropyl alcohol. Examples of the aprotic solvent include nitriles such as R—CN (where R is a C2 to C20 linear, branched, or cyclic hydrocarbon group, and may include a double bond, an aromatic ring, or an ether group); amides such as dimethylformamide; dioxolanes such as 1,3-dioxolane and 1,4-dioxolane; and sulfolanes.

The non-aqueous organic solvents may include used alone or in combination of two or more.

When a carbonate-based solvent is used, a mixture of a cyclic carbonate and a chain carbonate may include used, for example, in a volume ratio of about 1:1 to about 1:9.

The lithium salt is a material that is dissolved in the organic solvent and acts as a source of lithium ions in the battery to enable basic operation of the rechargeable lithium battery and promotes movement of lithium ions between the positive electrode and the negative electrode. Representative examples of the lithium salt may include one or two or more selected from LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide (LiFSI)), LiC₄F₉SO₃, LiN(CₓF₂ₓ₊₁SO₂)(C_{y}F_{2y+1}SO₂) (x and y are integers of 1 to 20), lithium trifluoromethane sulfonate, lithium tetrafluoroethane sulfonate, lithium difluorobis(oxalato)phosphate (LiDFOB), and lithium bis(oxalato) borate (LiBOB).

### Rechargeable Lithium Battery

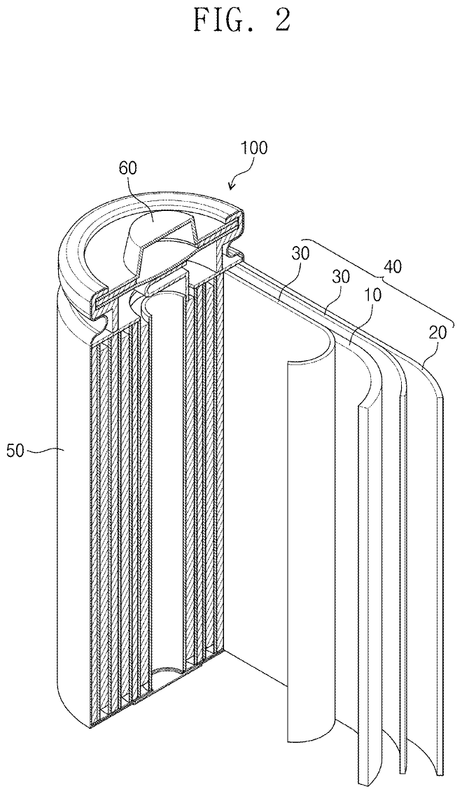

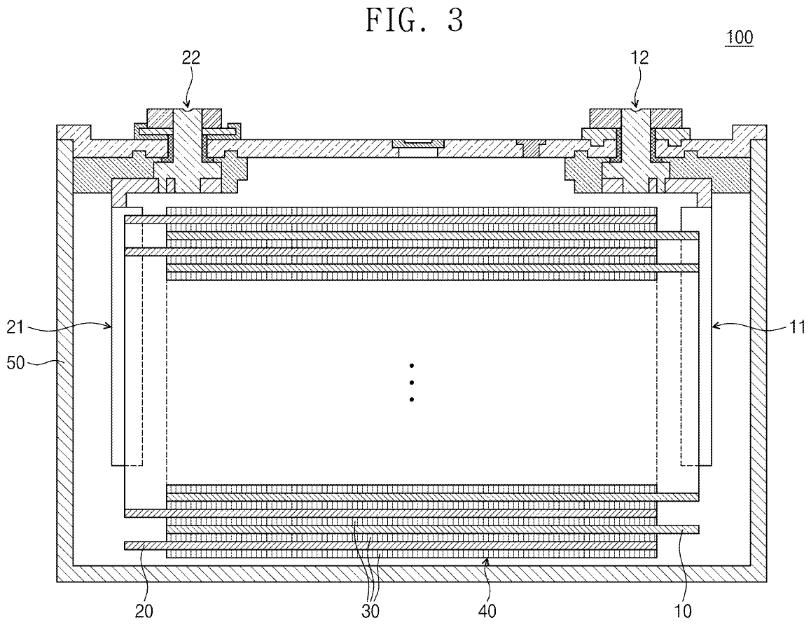

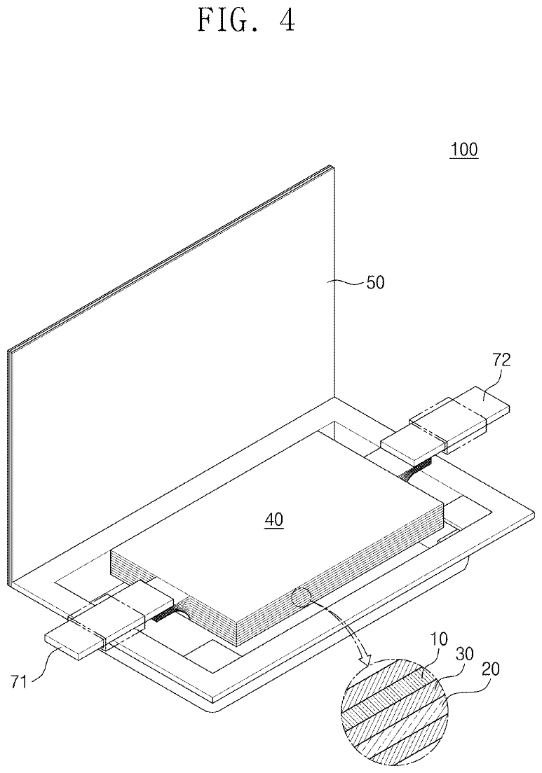

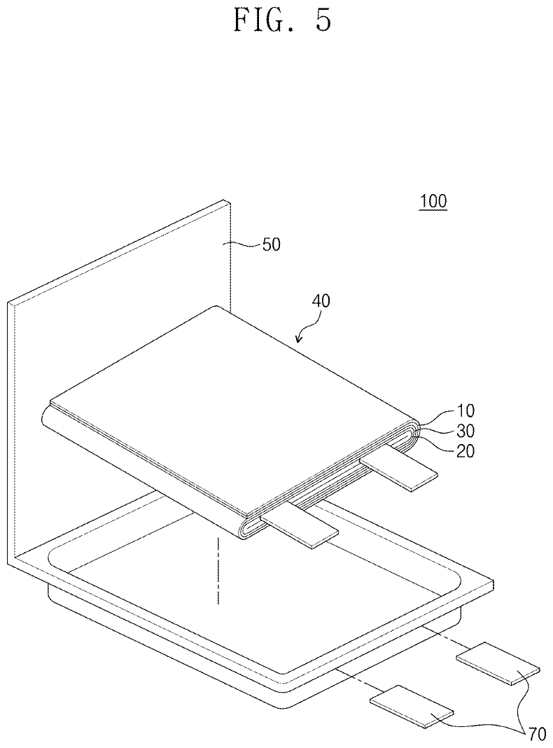

Rechargeable lithium batteries may include classified into cylindrical, prismatic, pouch, and coin types according to their shape. FIG. 2 to FIG. 5 are schematic views illustrating rechargeable lithium batteries according to various example embodiments, where FIG. 2 shows a cylindrical type, FIG. 3 shows a prismatic type, and FIG. 4 and FIG. 5 show pouch types. Referring to FIG. 2 to FIG. 4, a rechargeable lithium battery 100 includes an electrode assembly 40 in which a separator 30 is interposed between a positive electrode 10 and a negative electrode 20, and a case 50 in which the electrode assembly 40 is housed. The positive electrode 10, the negative electrode 20, and the separator 30 may include impregnated with an electrolyte (not shown). The rechargeable lithium battery 100 may include a sealing member 60 for sealing the case 50 as shown in FIG. 2. Also, as shown in FIG. 3, the rechargeable lithium battery 100 may include a positive electrode lead tab 11, a positive electrode terminal 12, a negative electrode lead tab 21, and a negative electrode terminal 22. As shown in FIG. 4 and FIG. 5, the rechargeable lithium battery 100 may include electrode tabs 70, namely a positive electrode tab 71 and a negative electrode tab 72, which serve as electrical paths for guiding the current formed in the electrode assembly 40 to the outside.

Hereinafter, rechargeable lithium batteries according to example embodiments of the present disclosure are described in more detail.

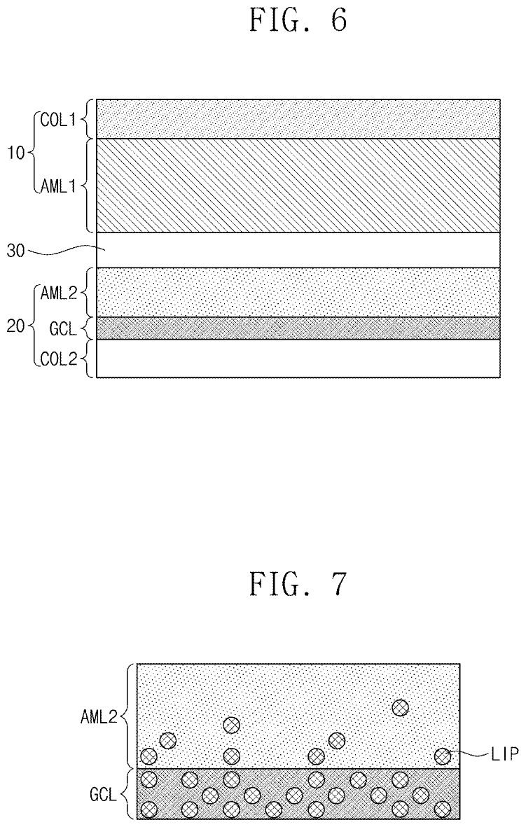

FIG. 6 is a cross-sectional view illustrating a rechargeable lithium battery according to example embodiments of the present disclosure.

Referring to FIG. 6, as previously described with reference to FIG. 1, the rechargeable lithium battery according to the present disclosure may include a positive electrode 10, a negative electrode 20, and a separator 30 between the positive electrode 10 and the negative electrode 20. Although not explicitly shown in FIG. 6, the rechargeable lithium battery may further include an electrolyte ELL. The separator 30 may include impregnated with the electrolyte ELL.

The positive electrode 10 may include a positive electrode current collector COL1 and a positive electrode active material layer AML1 on the positive electrode current collector COL1. The negative electrode 20 may include a negative electrode current collector COL2 and a negative electrode active material layer AML2 on the negative electrode current collector COL2. The separator 30 may include interposed between the positive electrode active material layer AML1 and the negative electrode active material layer AML2.

FIG. 7 is an enlarged view specifically showing a cross-section of a prelithiated carbon layer GCL and the negative electrode active material layer AML2.

Referring to FIG. 6 and FIG. 7, a prelithiated carbon layer GCL may include included between the negative electrode current collector COL2 and the negative electrode active material layer AML2. As used herein, the “prelithiated carbon layer GCL” may refer to a carbon layer in which pre-lithiation has proceeded through the intercalation of lithium. The thickness of the prelithiated carbon layer GCL may include greater than about 0 μm and about 5 μm or less. If the prelithiated carbon layer is absent, the bonding strength between the negative electrode active material layer AML2 and the negative electrode current collector COL2 may include insufficient, leading to weakened mechanical strength. If the thickness of the prelithiated carbon layer GCL exceeds about 5 μm, the volume of the rechargeable lithium battery may increase, thereby decreasing energy density.

Lithium in the prelithiated carbon layer GCL may exist in one or more forms of lithium metal, a lithium-carbon mixture, lithium oxide, lithium carbonate, or lithium ions. By interposing the prelithiated carbon layer GCL between the negative electrode current collector COL2 and the negative electrode active material layer AML2, the bonding strength between the negative electrode active material layer AML2 and the negative electrode current collector COL2 can be improved by the carbon layer. The prelithiated carbon layer GCL can reduce initial irreversible capacity.

Referring to FIG. 7, the atomic fraction of lithium atoms in the prelithiated carbon layer GCL may include greater than the atomic fraction of lithium atoms in the negative electrode active material layer AML2. More specifically, at a state of charge (SOC) of 0%, the atomic fraction of lithium atoms in the prelithiated carbon layer GCL at the interface between the negative electrode active material layer AML2 and the prelithiated carbon layer GCL may include greater than the atomic fraction of lithium atoms in the negative electrode active material layer AML2. In a dry negative electrode manufacturing process, if lithium is intercalated into the carbon layer before laminating the negative electrode film, lithium atoms remain in the prelithiated carbon layer GCL even after charging and discharging proceed, and thus the atomic fraction may become greater than that of lithium atoms in the negative electrode active material layer AML2.

The atomic fraction of lithium atoms in the negative electrode active material layer AML2 and the prelithiated carbon layer GCL can be calculated through X-ray photoelectron spectroscopy (XPS) analysis. Specifically, a sample of the negative electrode 20 is taken and fixed so that the sample surface is perpendicular to the direction of the XPS light source. Argon ions are sputtered to etch the surface of the negative electrode in the depth direction at regular intervals, and Li 1s and C 1s peaks are measured at each depth using XPS equipment. The atomic fraction of lithium atoms in the depth direction can be calculated by comparing the peak areas of each element. The sampling of the cross-section for determining the atomic fraction may be performed, for example, on an area of about 1 cm by about 1 cm.

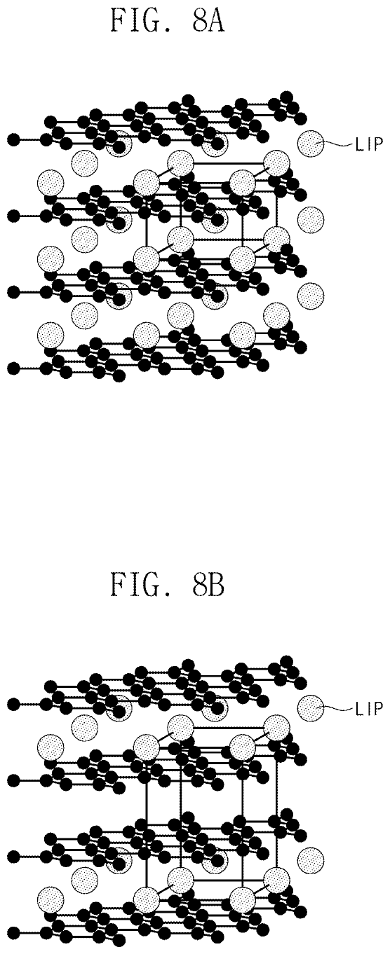

FIG. 8a and FIG. 8b are conceptual diagrams illustrating the prelithiated carbon layer GCL in which lithium is intercalated according to an embodiment of the present disclosure.

According to an embodiment shown in FIG. 8a and FIG. 8b, lithium atoms may be inserted between carbon layers. When lithium atoms are inserted to a maximum extent, a structure in which lithium atoms are inserted between every carbon layer (LiC₆ structure) may be formed as shown in FIG. 8a. In the LiC₆ structure, one lithium atom is adjacent to six carbon atoms, the molar ratio (Li/C) of lithium atoms is 1/6, and the atomic fraction is about 16.67 at %. When lithium atoms are inserted at every other layer, a LiC₁₂ structure may be formed as shown in FIG. 8b. In the LiC₁₂ structure, one lithium atom is adjacent to twelve carbon atoms, the molar ratio (Li/C) of lithium atoms is 1/12, and the atomic fraction is about 8.33 at %. According to example embodiments of the present disclosure, the atomic fraction of lithium atoms in the prelithiated carbon layer GCL may include about 5.56 at % or more and about 16.67 at % or less.

FIG. 9 is a cross-sectional view of a negative electrode 20 in which a lithium metal layer LIL is interposed between a prelithiated carbon layer GCL and a negative electrode active material layer AML2 according to an embodiment of the present disclosure.

Referring to FIG. 9, the lithium metal layer LIL may include a metal layer that remains even after the prelithiated carbon layer GCL is formed by performing pre-lithiation on a carbon layer. The lithium metal layer LIL may have a thickness of about 5 μm or less. If the thickness exceeds about 5 μm, the energy density of the rechargeable lithium battery may decrease, potentially weakening electrochemical characteristics.

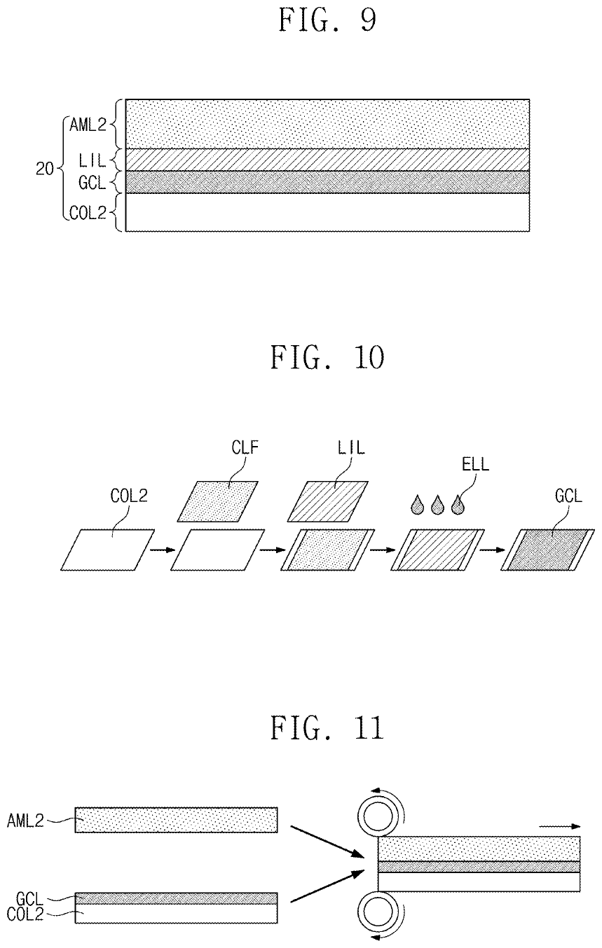

FIG. 10 and FIG. 11 are process diagrams schematically illustrating a method of manufacturing a dry negative electrode according to example embodiments of the present disclosure.

Referring to FIG. 10, first, a carbon layer CLF may be disposed on a negative electrode current collector COL2. Disposing the carbon layer CLF may include preparing a carbon layer slurry and coating the same on the negative electrode current collector COL2. The carbon layer slurry may include a mixture of carbon, a binder, a conductive material, and an additive. The ratio of the binder to carbon in the carbon layer slurry may be determined in a range of about 40:60 to about 60:40 depending on the bonding strength with the negative electrode current collector COL2.

Referring again to FIG. 10, a lithium metal layer LIL may be disposed on the carbon layer CLF, and an electrolyte ELL may be sprayed on the lithium metal layer LIL to form a prelithiated carbon layer GCL. The electrolyte ELL may serve to intercalate lithium atoms from the lithium metal layer LIL into the carbon layer CLF. In this case, the thickness of the lithium metal layer LIL may include greater than about 0% and about 30% or less of the thickness of the carbon layer CLF. If the ratio of the thickness of the lithium metal layer LIL to the thickness of the carbon layer CLF exceeds about 30%, the lithium metal layer becomes too thick, which may hinder the smooth intercalation of lithium atoms into the carbon layer by the electrolyte.

Referring to FIG. 10 and FIG. 11, a dry negative electrode for a rechargeable lithium battery may be manufactured by providing a film-type negative electrode active material layer AML2 manufactured by a dry process on the formed prelithiated carbon layer GCL. The dry negative electrode may be manufactured by a method of pressurizing the negative electrode current collector COL2, the prelithiated carbon layer GCL, and the negative electrode active material layer AML2. More specifically, the pressurizing may be performed by rolling using a roll press.

The negative electrode for a rechargeable lithium battery according to the present disclosure can provide lithium ions for pre-lithiation. The rechargeable lithium battery according to the present disclosure can exhibit desired or improved capacity and maintain energy density by improving the initial irreversible capacity problem associated with dry processes.

Hereinafter, Examples and Comparative Examples of the present disclosure are described. However, the following examples are merely example embodiments, and the present disclosure is not limited thereto.

### Example 1

### (1) Manufacture of Negative Electrode

### (Preparation of Carbon Layer Slurry)

A carbon layer slurry was prepared by mixing carbon (a mixture of synthetic graphite and carbon black in a ratio of 85:15) and a binder (polyacrylic acid (PAA), AS58) with a deionized water (DIW) solvent. The ratio of carbon to binder in the carbon layer was 50:50.

### (Manufacture of Prelithiated Carbon Layer)

A Cu foil with a thickness of 15 μm was prepared as a negative electrode current collector. The carbon layer slurry was coated on the negative electrode current collector and dried to form a carbon layer with a thickness of 3 μm. A lithium metal layer with a thickness of 1 μm was disposed on the carbon layer, and an electrolyte was applied. The assembly was left at room temperature for 1 hour to intercalate lithium atoms from the lithium metal layer into the carbon layer, thereby manufacturing a prelithiated carbon layer.

### (Manufacture of Negative Electrode Active Material Layer)

A negative electrode active material (a mixture of synthetic graphite and silicon nanoparticles in a weight ratio of 93:7) and a dry binder (polytetrafluoroethylene (PTFE)) were mixed in a weight ratio of 99:1 and then rolled using a roll press to form a negative electrode active material layer in the form of a film.

### (Manufacture of Negative Electrode)

The negative electrode according to this example was manufactured by sequentially laminating the negative electrode current collector, the prelithiated carbon layer, and the negative electrode active material layer, followed by rolling using a roll press.

### (2) Manufacture of Rechargeable Lithium Battery

An Al foil with a thickness of 15 μm was prepared as a positive electrode current collector. A positive electrode active material slurry was prepared by mixing a positive electrode active material (LiNiCoAlO₂ (NCA)), a binder (polyvinylidene fluoride), and a conductive material (acetylene black) in a weight ratio of 96:3:1 and dispersing the mixture in N-methylpyrrolidone.

The positive electrode active material slurry was coated on the current collector, dried at 100 °C, and then pressed to manufacture a positive electrode.

An electrode assembly was manufactured by assembling the positive electrode, the negative electrode, and a separator made of polyethylene with a thickness of 10 μm. An electrolyte was injected to manufacture a rechargeable lithium battery.

### Comparative Example 1

A negative electrode and a rechargeable lithium battery were manufactured in the same manner as in Example 1, except that the lithium metal layer was omitted. Specifically, the negative electrode of Comparative Example 1 was manufactured by sequentially laminating a negative electrode current collector, a carbon layer, and a negative electrode active material layer.

### Comparative Example 2

A negative electrode and a rechargeable lithium battery were manufactured in the same manner as in Example 1, except that the carbon layer was omitted. Specifically, the negative electrode was manufactured by disposing a lithium metal layer on a negative electrode current collector and then laminating a negative electrode active material layer thereon.

### Evaluation Example 1: Evaluation of Bonding Strength Between Current Collector and Active Material

For the rechargeable lithium batteries of Example 1, Comparative Example 1, and Comparative Example 2, each negative electrode was collected separately to evaluate the bonding strength between the negative electrode current collector and the negative electrode active material layer. Specifically, samples were prepared in a size of 10 mm×50 mm, and 3M strong adhesive tape was attached to the surface of the active material layer. The peel strength was measured by pulling in a 180-degree peel method using a Universal Testing Machine (UTM). Five samples were measured for each, and the average values are shown in Table 1.

TABLE 1

| | | Comparative | Comparative |
|---|---|---|---|
| Category | Example 1 | Example 1 | Example 2 |
| Bonding Strength (N/m) | 1.42 | 1.47 | 0.18 |

Referring to Table 1, it can be confirmed that the bonding strength of Example 1 and Comparative Example 1, where a carbon layer is formed between the negative electrode current collector and the negative electrode active material layer, is superior to that of Comparative Example 2. Example 1 and Comparative Example 1 show equivalent levels of bonding strength, which suggests that the presence of a carbon layer on the negative electrode current collector provides superior bonding strength compared to its absence, regardless of whether pre-lithiation is performed.

### Evaluation Example 2: Evaluation of Initial Irreversible Capacity

The initial irreversible capacity of the rechargeable lithium batteries was evaluated through a charge-discharge test. The test was conducted using a constant current-constant voltage (CC-CV) method. From a fully discharged state, the batteries were charged at a constant current of 1C until the voltage reached 4.2V. Upon reaching 4.2V, the first charge was performed at a constant voltage of 4.25V with a 0.05C cut-off condition. Subsequently, the first discharge was performed at a constant current of 0.1C until the voltage reached 2.75V to complete the first cycle. Initial irreversible capacity and initial efficiency were calculated using the following equations. The average values for five samples are shown in Table 2.

Initial irreversible capacity (mAh/cm²)=Charge capacity−Discharge capacity [Equation 1]

Initial efficiency (%)=(Discharge capacity/Charge capacity)×100 [Equation 2]

TABLE 2

| | | Comparative | Comparative |
|---|---|---|---|
| Category | Example 1 | Example 1 | Example 2 |
| Design Capacity | 6.00 | 6.00 | 6.00 |
| (mAh/cm²) | | | |
| Charge Capacity | 5.89 | 5.84 | 5.77 |
| (mAh/cm²) | | | |
| Discharge Capacity | 5.47 | 5.08 | 5.32 |
| (mAh/cm²) | | | |
| Irreversible Capacity | 0.42 | 0.76 | 0.45 |
| (mAh/cm²) | | | |
| Initial Efficiency | 92.87 | 86.99 | 92.20 |
| (%) | | | |

Referring to Table 2, Comparative Example 1, which was not pre-lithiated, exhibits the largest irreversible capacity, similar to levels seen in conventional dry-process rechargeable lithium batteries.

Example 1 exhibits a smaller initial irreversible capacity than Comparative Example 1. It can be seen that lithium atoms in the prelithiated carbon layer compensate for lithium loss during initial charging and discharging, thereby improving the initial irreversible capacity and efficiency.

Comparative Example 2 shows an initial irreversible capacity equivalent to Example 1. This indicates that lithium atoms from the lithium metal layer were intercalated into the negative electrode active material layer during initial charging and discharging, causing pre-lithiation to proceed.

### Evaluation Example 3: Evaluation of Li Atomic Fraction

The atomic fraction of lithium atoms was evaluated through XPS analysis in a fully discharged state (SOC 0%) after a formation process. The negative electrodes were cut into 1 cm×1 cm pieces and fixed in the XPS equipment. The samples were etched every 5 seconds using Ar ion sputtering, and the peak area of each element was measured to calculate the atomic fraction of lithium atoms in the depth direction. The average values for five samples are shown in Table 3.

TABLE 3

| | | Compar- | Compar- |
|---|---|---|---|
| | | ative | ative |
| | Exam- | Exam- | Exam- |
| Category | ple 1 | ple 1 | ple 2 |
| Negative Electrode Active Material | 0.12 | 0.10 | 3.31 |
| Layer Li Atomic Fraction (at %) | | | |
| Prelithiated Carbon Layer (Carbon | 7.68 | 0.01 | — |
| Layer) Li Atomic Fraction (at %) | | | |

Referring to Table 3, in Comparative Example 2, since no carbon layer was formed and pre-lithiation proceeded directly in the negative electrode active material layer, the lithium atomic fraction in the active material layer is higher than those in Example 1 and Comparative Example 1.

In Example 1, where the prelithiated carbon layer was formed, it can be confirmed that the lithium atomic fraction in the prelithiated carbon layer is significantly higher than that in the negative electrode active material layer. This contrasts with Comparative Example 1, where pre-lithiation was not performed, and the lithium atomic fraction in the carbon layer is very low.

Preferred example embodiments of the present disclosure have been described above, but the present disclosure is not limited thereto. Various modifications can be made within the scope of the claims, the detailed description, and the accompanying drawings, and such modifications also fall within the scope of the present disclosure.

What is claimed is:

1. A dry negative electrode for a rechargeable lithium battery, comprising:
a negative electrode current collector;
a prelithiated carbon layer on the negative electrode current collector; and
a negative electrode active material layer on the prelithiated carbon layer,
wherein an atomic fraction of lithium atoms in the prelithiated carbon layer is greater than an atomic fraction of lithium atoms in the negative electrode active material layer.

2. The dry negative electrode of claim 1, wherein the prelithiated carbon layer comprises at least one of lithium metal, a lithium-carbon compound, lithium oxide, lithium carbonate, and lithium ions.

3. The dry negative electrode of claim 1, wherein at a state of charge (SOC) of 0%, the atomic fraction of lithium atoms in the prelithiated carbon layer at the interface between the negative electrode active material layer and the prelithiated carbon layer is greater than the atomic fraction of lithium atoms in the negative electrode active material layer.

4. The dry negative electrode of claim 1, further comprising a lithium metal layer between the prelithiated carbon layer and the negative electrode active material layer.

5. The dry negative electrode of claim 4, wherein a thickness of the lithium metal layer is 5 μm or less.

6. The dry negative electrode of claim 1, wherein a thickness of the prelithiated carbon layer is in a range of 0 μm to 5 μm.

7. The dry negative electrode of claim 1, wherein the atomic fraction of lithium atoms in the prelithiated carbon layer is in a range of 5.56 at % to 16.67 at %.

8. The dry negative electrode of claim 1, wherein the negative electrode active material layer comprises a dry binder.

9. The dry negative electrode of claim 8, wherein the negative electrode active material layer further comprises a carbon-based negative electrode active material and a silicon-based negative electrode active material.

10. A rechargeable lithium battery comprising:
a positive electrode;
a negative electrode; and
an electrolyte between the positive electrode and the negative electrode,
wherein the negative electrode comprises the dry negative electrode according to claim 1.

11. The rechargeable lithium battery of claim 10, wherein the positive electrode comprises a lithium transition metal composite oxide.

12. The rechargeable lithium battery of claim 10, wherein the positive electrode is manufactured by a wet process or a dry process.

13. The rechargeable lithium battery of claim 10, wherein the electrolyte comprises a liquid electrolyte.

14. A method of manufacturing a dry negative electrode for a rechargeable lithium battery, the method comprising:
forming a carbon layer on a negative electrode current collector;
disposing a lithium metal layer on the carbon layer;
spraying an electrolyte on the lithium metal layer to form a prelithiated carbon layer; and
providing a negative electrode active material layer manufactured by a dry process on the prelithiated carbon layer.

15. The method of claim 14, wherein a ratio of a thickness of the lithium metal layer to a thickness of the carbon layer is in range of 0% to 30%.

16. The method of claim 14, wherein forming the carbon layer comprises coating a carbon layer slurry on the negative electrode current collector.

17. The method of claim 16, wherein a ratio of a binder to carbon in the carbon layer slurry is in a range of 40:60 to 60:40.

18. The method of claim 14, wherein lithium in the lithium metal layer is intercalated into an interior of the carbon layer by the electrolyte.

19. The method of claim 14, further comprising pressurizing the negative electrode current collector, the prelithiated carbon layer, and the negative electrode active material layer.

20. The method of claim 19, wherein the pressurizing is performed using a roll press.
